(19) United States
(12) Patent Application Publication
(10) Pub. No.: US 2005/0055532 A1
(43) Pub. Date: Mar. 10, 2005

(54) Method for efficiently controlling read/write of flash memory

(76) Inventor: James Yu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/933,266

(22) Filed: Sep. 3, 2004

(30) Foreign Application Priority Data
Sep. 5, 2003 (TW) 92124549

(51) Int. Cl. G06F 12/08

(52) U.S. Cl. 711/203; 711/103; 711/202

(57) ABSTRACT

A method for efficiently controlling read/write of a flash memory is proposed, wherein two address mapping tables and an empty block FIFO mechanism are built. A zone address mapping table matched with its empty block FIFO data is used for the logical address of the file allocation table (FAT). When a host end performs read/write to a flash memory, no matter to which zone the zone address mapping table corresponds, it is not necessary to rebuild the FAT address mapping table. Moreover, a cache address mapping table and its empty block FIFO data can be added. When the logical address is not in the zone address mapping table and the FAT address mapping table, a smaller cache address mapping table is first built to increase the system speed, let control of the flash memory be more efficient, and distribute the utility rate of each block.

### FIELD OF THE INVENTION

The present invention relates to a read/write control method of a flash memory and, more particularly, to a method for efficiently controlling read/write of a flash memory to increase the read/write speed of the flash memory.

### BACKGROUND OF THE INVENTION

In the operation principle of memory, when a controller uses a memory as a data storage region, the calculation results and data will be stored in the memory. When writing data into a memory, the controller will define the position of memory with necessary information so as to send data to an accurate address via an address bus. When reading data, the controller first executes an instruction to obtain the address data. The memory then responds to send data to the controller. The time from when the controller executes the instruction to when the controller exactly receives data from the memory is called the access time of the memory.

A flash memory uses a block composed of several bytes as the unit for storage and readout of data. Each block for data access has a physical address to represent the space order in the flash memory. Simultaneously, each block records a logical address marked by the file system at the host end to let each physical address have a corresponding logical address. In the flash mechanism, however, because the correspondence relation between the physical address and the logical address required for data access at the host end is nonlinear, the logical address can't be directly inferred from the physical address, as shown in FIG. 1. In order to avoid the search from beginning to end for data access each time, a logical/physical address mapping table (address mapping table) is generally built to obtain the corresponding logical address.

The logical/physical address mapping table (a table for recording the mapping relation between logical address and physical address) is first built when the system is booted. A 2 K static random access memory (SRAM) is designed to record the address mapping table. When there are two or more address mapping tables or there is a larger address mapping table, it is necessary to increase the number or capacity of the SRAM. This will result in increase of the size of the control chip of flash memory. If the flash memory has more than one zone and the SRAM is constant, if the address at the host end is not in the address mapping table, it is necessary to search another zone of the flash memory once and then fill the corresponding physical address in the address mapping table for facilitating subsequent data access. Software can be used to search the address mapping table in the SRAM to quickly obtain the physical address corresponding to the logical address. For read/write of a flash memory, the time required for writing in data is longer than that for reading out data. Moreover, when writing data into a memory, it is necessary to consider whether there is data at the address to be written in. If there is already data at the address to be written in, it is necessary to first write the data into an empty block, move the data in the block address to be written in to a new block, and change the address mapping table to let the next address from the host end correspond to the physical address. In other words, the write-in action of flash memory is very complicated, especially for searching a wholly new block. It may be necessary to search all blocks to find a usable empty block.

Accordingly, the present invention aims to propose a method for efficiently controlling read/write of a flash memory to solve the above problems in the prior art.

### SUMMARY OF THE INVENTION

The primary object of the present invention is to provide a method for efficiently controlling read/write of a flash memory to let control of the flash memory be more efficient and shrink the size of the control chip of the flash memory.

Another object of the present invention is to provide a method for efficiently controlling read/write of a flash memory, which makes use of the idea of an empty block FIFO mechanism to reduce the number of times of searching the flash memory and also increase the write-in speed of data.

Yet another object of the present invention is to provide a method for efficiently controlling read/write of a flash memory to let the utility rate of each block be very even.

To achieve the above objects, the present invention first sets a plurality of blocks in a flash memory as a zone. When the system is booted, three logical/physical address mapping tables are built based on the relationship between block addresses and corresponding logical addresses. The three address mapping tables include a FAT address mapping table, a zone address mapping table of Zone 0, and a cache address mapping table of part blocks of Zone 1. When the host end sends out a logical address to be looked up, if the logical address to is in the FAT of the flash memory, the corresponding physical address is directly found from the FAT address mapping table. Otherwise, to which block of which zone the logical address to be looked up belongs is first calculated. When the calculation result shows the logical address to be looked up is in Zone 0, the physical address can be found from the zone address mapping table of Zone 0. If the logical address to be looked up is not in Zone 0, the cache address mapping table is searched. When the cache address mapping table has not the logical address to be looked up, another cache address mapping table is rebuilt according to the calculation result. Whether a zone address mapping table of another zone is to be rebuilt is then determined according to the search result until the physical address corresponding to the logical address to be looked up is found for readout or write-in of data.

When building the FAT address mapping table, the zone address mapping table and the cache address mapping table, three sets of corresponding empty block FIFO data are built simultaneously. When data are written into the flash memory, if the physical address corresponding to the logical address to be looked up is found in one of the three address mapping tables, the FIFO principle is utilized to directly find an empty block from the FIFO data of the address mapping table, new data are written into this empty block, and original data of the physical address are then copied to this empty block. Next, the data in the physical address are erased. Finally, the correspondence relationship between the logical and physical address of the new block is built into the address mapping table, and the empty block whose data therein are erased above is added into the FIFO data.

The various objects and advantages of the present invention will be more readily understood from the following detailed description when read in conjunction with the appended drawings, in which:

### BRIEF DESCRIPTION OF THE DRAWINGS

FIG. 1 is a diagram showing the relationship between physical addresses and logical addresses in a conventional flash memory and a logical/physical address mapping table built according to this relationship; and

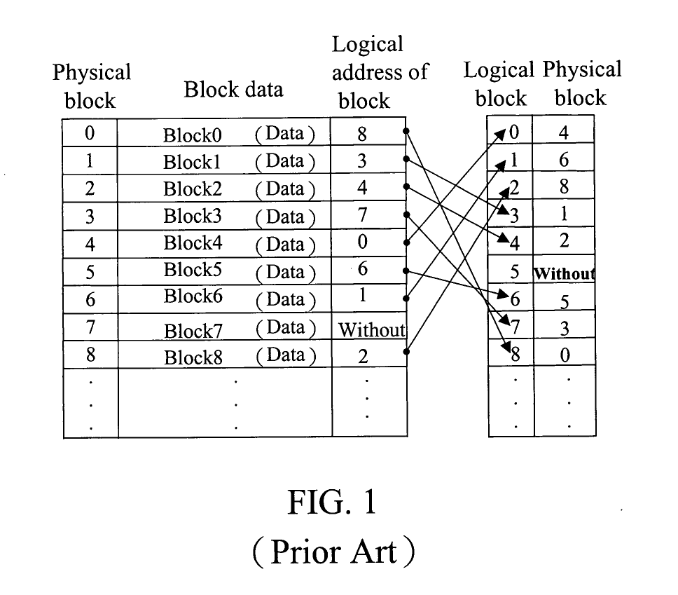

FIG. 2 is an architecture diagram of detecting the logical address of the present invention.

### DETAILED DESCRIPTION OF THE PREFERRED EMBODIMENTS

A secure digital (SD) card controller receives data of several kinds of electronic products like card readers and digital still cameras from a host end and then store into a flash memory. In order to let control of flash memory be more efficient and reduce the chip size of the controller, an algorithm of logical/physical address mapping table is proposed.

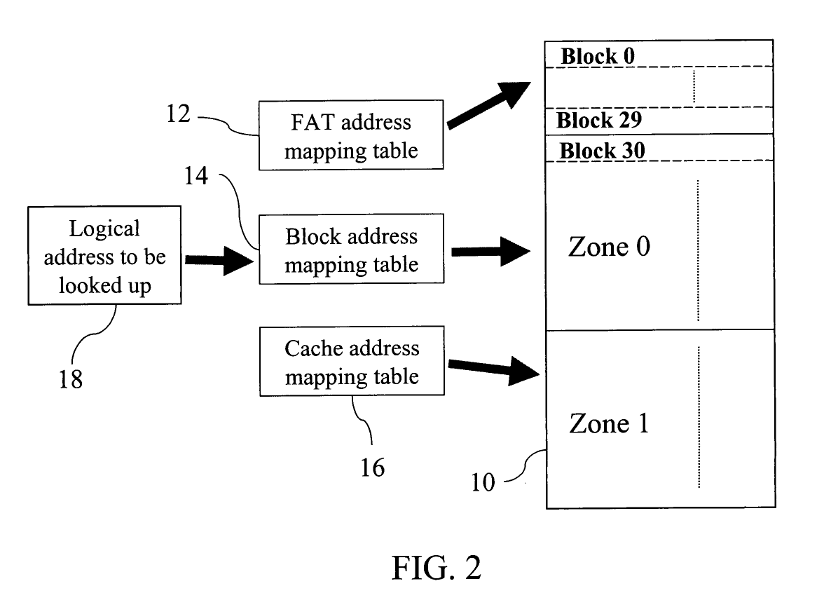

Basically, the internal architecture of flash memory can be divided into three units: zone, block and page. In the present invention, a plurality of blocks in a flash memory 10 are set as a zone. When the system is booted, three logical/physical address mapping tables are built based on the relationship between each block address and its corresponding logical address. The three address mapping tables include a FAT address mapping table 12, a zone address mapping table 14 of Zone 0, and a cache address mapping table 16 of part blocks of Zone 1, as shown in FIG. 2. The FAT address mapping table 12 is directly built in a random access memory (RAM) in a CPU to have a higher efficiency. Moreover, the FAT empty block FIFO data are also built in the RAM in the CPU. The zone address mapping table 14 and the cache address mapping table 16 and their empty block FIFO data are built in an built-in SRAM of the SD card controller.

When the host end sends out a logical address 18 to be looked up to the controller of the flash memory, if the logical address 18 is in the FAT of the flash memory, the corresponding physical address is directly found from the FAT address mapping table 12. Otherwise, a divider is first used to calculate to which block of which zone the logical address 18 belongs. When the calculation result shows the logical address 18 is in Zone 0, the physical address can be found from the zone address mapping table 14 of Zone 0. If the logical address to be looked up is not in Zone 0, the cache address mapping table 16 is searched.

When the cache address mapping table 16 has not the logical address 18 to be looked up, another cache address mapping table 16′ is rebuilt according to the above calculation result. Whether a zone address mapping table 14′ of another zone is to be rebuilt is then determined according to the search result until the physical address corresponding to the logical address 18 to be looked up is found for readout or write-in of data. Only a cache address mapping table will be built for each zone.

When the logical address to be looked up at the host end is not in Zone 0 and the cache block of Zone 1, it is necessary to rebuild a cache address mapping table. If the logical address to be looked up at the host end is not in Zone 0 but in Zone 1, it is necessary to rebuild a zone address mapping table of Zone 1 so that the host end can search the corresponding physical address.

Besides, when building the FAT address mapping table 12, the zone address mapping table 14 and the cache address mapping table 16, three sets of corresponding empty block FIFO data (not shown) are built simultaneously. If the physical address corresponding to the logical address 18 to be looked up is found in one of the three address mapping tables 12, 14 and 16, the FIFO principle is utilized to directly find an earliest existent new empty block from the FIFO data of the address mapping table, new data are written into this empty block, and original data of the physical address are then copied to this empty block. Next, the data in the physical address are erased. Finally, the correspondence relationship between the logical and physical address of the new block is built into the address mapping table, and the empty block whose data therein are erased above is added into the FIFO data. Therefore, each address mapping table is matched with an empty block FIFO data to effectively enhance the efficiency of the flash memory and let the utility rate of each block be even.

In order to reduce the number of times of searching empty blocks of the flash memory, an empty block FIFO mechanism is built in the present invention to collect unused blocks in a zone together. Whenever data are written into the flash memory, an empty block is directly caught from this FIFO data so that data can be directly written into this physical address, hence reducing the number of times of searching empty blocks of the flash memory. Moreover, during the write-in process of data, it is not necessary to recheck whether pages in each block have been used, hence enhancing the speed. Besides, in order to reduce the number of times of rebuilding the empty block FIFO data, when a zone is erased, its physical address will be stored into this FIFO data. Therefore, whenever a block is used, a physical address will be added into the FIFO buffer data. The probability of rebuilding the FIFO data is thus low, and the utility rate of each block will be very even.

For the operation principle of flash memory, each zone has 1024 blocks. When the capacity of a flash memory exceeds 16 M bytes, there will be more than two zones. In order to provide enough turnover space, each zone will only use 1000 blocks. The remaining blocks will be viewed as reserved blocks for turnover space of data. Therefore, if a flash memory is 128 M bytes, there will be 8 zones and 8192 usable blocks totally. In the present invention, only 8000 blocks are used and evenly distributed in the 8 zones. There are 24 blocks reserved in each zone. Therefore, the logical address from the host end won't exceed 7999. It is only necessary to divide the logical address by 1000 (a fixed number determined by the number of blocks of a zone) to calculate out in which zone the logical address is and its corresponding shift in the address mapping table. The corresponding physical address can thus be directly found. However, because the RAM for storing the zone address mapping table is only 2 K bytes, it is necessary to make sure whether the zone corresponding to the address mapping table is the one corresponding to the logical address. If the answer is negative, it is necessary to rebuild another zone address mapping table. Moreover, in order to speed up address calculation, a divider is designed in the present invention. It is only necessary to input the logical address to automatically generate the quotients and remainders for division by 1000 and 128. The physical address in the address mapping table can thus be directly found to enhance the system efficiency.

Furthermore, because change of the FAT is very frequent, a FAT address mapping table and its empty block FIFO data are added to directly correspond to logical addresses 0˜39. Once the logical address from the host end is between 0˜39, no matter to which zone the present zone address mapping table corresponds, it is not necessary to rebuild the zone address mapping table. It is only necessary to directly fond the corresponding address from this FAT address mapping table, hence reducing the number of times of rebuilding the zone address mapping table.

Next, in order to reduce the number of times of rebuilding the whole zone address mapping table, a cache address mapping table and a cache empty block FIFO data are further added. The capacity of this cache address mapping table is 256 bytes, and can accommodate a space of 128 blocks. When the logical address from the host end is not in the zone address mapping table and the FAT address mapping table, the corresponding address is found from this cache address mapping table. If this logical address is not in this cache address mapping table, it is necessary to rebuild this cache address mapping table. Because this cache address mapping table has only 128 blocks, the speed of rebuilding this cache address mapping table will be faster than that of rebuilding the zone address mapping table having 2 K blocks, hence reducing the number of times of rebuilding the whole zone address mapping table.

Moreover, the present invention also proposes another way to more enhance the present architecture. The above FAT address mapping table 12 and its empty block FIFO data are reserved, while the cache address mapping table 16 and its empty block FIFO data are eliminated. The size of the original zone address mapping table 14 is changed from 1024 blocks to 256 blocks. The zone address mapping table is directly searched until the physical address corresponding to the logical address to be looked up is found for readout or write-in of data. This way can reduce the time of rebuilding address mapping tables and also decrease the size of SRAM from the original 2 K bytes to 512 bytes. Three fourths of SRAM is reduced and four times of efficiency is increased, hence lowering the cost and increasing the efficiency.

To sum up, the present invention matches the zone address mapping table with its empty block FIFO data. This idea is also applied to the logical address of the FAT. When the system accesses the flash memory, no matter to which zone the zone address mapping table corresponds, it is not necessary to rebuild the FAT address mapping table. Moreover, a cache address mapping table is added. When a logical address is not in the zone address mapping table and the FAT address mapping table, the smaller cache address mapping table is first built to exactly increase the system speed.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. A method for efficiently controlling read/write of a flash memory comprising the steps of:
setting a plurality of blocks in said flash memory as a zone, building three logical/physical address mapping tables based on the relationship between block addresses and corresponding logical addresses when the system is booted, said three address mapping tables being a FAT address mapping table, a zone address mapping table of Zone 0, and a cache address mapping table of part blocks of Zone 1; and
directly finding the physical address from said FAT address mapping table when the host end sends out a logical address to be looked up if the logical address is in the FAT of said flash memory, calculating to which block of which zone said logical address to be looked up belongs otherwise, finding the physical address from said zone address mapping table of Zone 0 when the calculation result shows said logical address to be looked up is in Zone 0, searching said cache address mapping table if said logical address to be looked up is not in Zone 0, rebuilding another cache address mapping table according to the calculation result when said cache address mapping table has not said logical address to be looked up, determining whether a zone address mapping table of another zone is to be rebuilt according to the search result until the physical address corresponding to said logical address to be looked up is found for readout or write-in of data.

2. The method as claimed in claim 1, wherein three sets of corresponding empty block FIFO data can be simultaneously built when building said three address mapping tables, if the physical address corresponding to said logical address to be looked up is found in one of said three address mapping tables, a new empty block is first found from the FIFO data of said address mapping table, new data are written into said empty block, original data of the physical address are copied to said empty block, the data in the physical address are then erased, the correspondence relation between said logical and physical addresses of the new block is finally built into said address mapping table, and said empty block whose data therein are erased above is added into the FIFO data.

3. The method as claimed in claim 2, wherein the FIFO principle is based on for selecting the earliest existent empty block in the step of selecting a new empty block from said FIFO data.

4. The method as claimed in claim 1, wherein only a cache address mapping table is built for each said zone.

5. The method as claimed in claim 1, wherein a divider is used for calculation in the step of calculating to which block of which zone said logical address to be looked up belongs.

6. The method as claimed in claim 5, wherein a first fixed number is determined according to the number of blocks of said zone, said logical address to be looked up is divided by said first fixed number, the obtained quotient represents a zone in said memory corresponding to said logical address to be looked up, and the obtained remainder represents a shift of said zone address mapping table corresponding to said logical address to be looked up.

7. The method as claimed in claim 6, wherein a second fixed number is further determined according to the number of blocks of said cache, the calculated remainder is then divided by said second fixed number to obtain a shift of said address mapping table corresponding to said logical address to be looked up.

8. The method as claimed in claim 1, wherein new data are restricted in the same zone when writing data into said flash memory or renewing data in said flash memory.

9. The method as claimed in claim 1, wherein said zone address mapping table, said cache address mapping table and theirs empty block FIFO data are stored in a built-in random access memory of a SD controller.

10. The method as claimed in claim 1, wherein said FAT address mapping table and its empty block FIFO data are stored in a built-in random access memory of a CPU.

11. A method for efficiently controlling read/write of a flash memory comprising the steps of:
setting a plurality of blocks in said flash memory as a zone, building two logical/physical address mapping tables based on the relationship between block addresses and corresponding logical addresses when the system is booted, said three address mapping tables being a FAT address mapping table and a zone address mapping table of Zone 0;
when the host end sends out a logical address to be looked up, directly finding the physical address from said FAT address mapping table if said logical address is in the FAT of said flash memory, calculating to which zone said logical address to be looked up belongs otherwise; and
finding the physical address from said zone address mapping table of Zone 0 when the calculation result shows said logical address to be looked up is in Zone 0, rebuilding a zone address mapping table of another zone according to the calculation result when the calculation result shows said logical address to be looked up is not in Zone 0 until the physical address corresponding to said logical address to be looked up is found for readout or write-in of data.

12. The method as claimed in claim 11, wherein two sets of corresponding empty block FIFO data can be simultaneously built when building said two address mapping tables, if the physical address corresponding to said logical address to be looked up is found in one of said two address mapping tables, a new empty block is first found from the FIFO data of said address mapping table, new data are written into said empty block, original data of the physical address are copied to said empty block, the data in the physical address are then erased, the correspondence relation between said logical and physical addresses of the new block is finally built into said address mapping table, and said empty block whose data therein are erased above is added into the FIFO data.

13. The method as claimed in claim 12, wherein the FIFO principle is based on for selecting the earliest existent empty block in the step of selecting a new empty block from said FIFO data.

14. The method as claimed in claim 11, wherein a divider is used for calculation in the step of calculating to which block of which zone said logical address to be looked up belongs.

15. The method as claimed in claim 11, wherein new data are restricted in the same zone when writing data into said flash memory or renewing data in said flash memory.

16. The method as claimed in claim 11, wherein said zone address mapping table, said cache address mapping table and theirs empty block FIFO data are stored in a built-in random access memory of a SD controller.

17. The method as claimed in claim 11, wherein said FAT address mapping table and its empty block FIFO data are stored in a built-in random access memory of a CPU.
